(19) United States
(12) Patent Application Publication
(10) Pub. No.: US 2025/0077799 A1
(43) Pub. Date: Mar. 6, 2025

(54) ARTIFICIAL INTELLIGENCE SYSTEM FOR IDENTIFYING, EVALUATING, AND CONTROLLING OVERLAPPING RULE CODE

(71) Applicant: PAYPAL, INC., San Jose, CA (US)

(72) Inventors: Ming Yuan, Shanghai (CN); Tianshu Pan, Shanghai (CN); Xueqi Ma, Shanghai (CN); Shupeng Geng, Shanghai (CN); Weilian Shi, Shanghai (CN)

(21) Appl. No.: 18/459,136

(22) Filed: Aug. 31, 2023

(51) Int. Cl. G06F 40/55; G06N 3/042; G06N 3/08

(52) U.S. Cl. CPC G06F 40/55; G06N 3/042; G06N 3/08

(57) ABSTRACT

There are provided systems and methods of an artificial intelligence system for identifying, evaluating, and controlling overlapping rule code. A service provider, such as an electronic transaction processor for digital transactions, may utilize computing services that implement coded rules and rule-based engines for decision-making of data including real-time data processing in production computing environments. Multiple rules may overlap, and the service provider may utilize an AI system to identify the overlap by converting rule code and logic to syntax in a language. The syntax may then be analyzed for overlap and a similarity score calculated for pairwise similarity between each rule in the rule-based system. Thereafter, based on similarity scores and pairwise similarity, clusters of rule pairs may be identified in order to reduce rules through merging or deleting the same, similar, or overlapping rules based on their syntaxes.

### TECHNICAL FIELD

The present application generally relates to machine learning (ML) and other artificial intelligence (AI) systems and more particularly to detecting similar rules in ML and other AI systems using rule syntax clustering and similarity scores.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. The service provider may utilize one or more applications, platforms, and/or decision services that implement and utilize ML and other AI (e.g., neural networks (NN), rule-based engines, etc.) models for data processing, decision-making, classifications, predictions, and the like to provide computing services, such as electronic transaction processing, in a production computing environment. In such systems, rule writers may be utilized to write and configure rules that may act on input data, decisions and/or scores from models, and the like, in order to execute decisions on computing or transaction requests. However, different rules may be created and used by different rule writers and data scientists, which may produce duplicate or very similar rules that unnecessarily utilize computing resources and storages and may have different processing requirements and times. Thus, rule writers may benefit from identifying overlapping rule code in an automated manner to increase efficiency and productivity, as well as improve decision-making capabilities and reduce system resource usage of computing systems. As such, it is desirable to provide improved systems and processes for a rule helper that can provide a range of functionalities to help these rule writers and other users with their rule-writing tasks.

### BRIEF DESCRIPTION OF THE DRAWINGS

FIG. 1 is a block diagram of a networked system suitable for implementing the processes described herein, according to an embodiment;

FIG. 2A is an exemplary system environment where rules may be implemented and evaluated to control overlapping rule code, according to an embodiment;

FIG. 2B is an exemplary diagram of two rules having overlapping rule code that may be implemented as shown in FIG. 2A, according to an embodiment;

FIGS. 3A-3D are exemplary diagrams of operations to analyze rule syntax to identify, evaluate, and control overlapping rule code, according to an embodiment;

FIG. 4 is a flowchart of an exemplary process performed by a system for identifying, evaluating, and controlling overlapping rule code, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized by an AI system for identifying, evaluating, and controlling overlapping rule code. Systems suitable for practicing methods of the present disclosure are also provided.

A service provider may provide different computing resources and services to users through different websites, resident applications (e.g., which may reside locally on a computing device), and/or other online platforms. When utilizing the computing services of a particular service provider, the service provider may provide different operations through applications, platforms, decision services, and the like that utilize AI systems for intelligent decision-making operations with such services and to provide outputs to users. For example, an online transaction processor may provide computing services associated with electronic transaction processing, digital accounts and account services, user authentication and verification, digital payments, risk analysis and compliance, and the like. Other exemplary services may include shopping and merchant marketplaces, social networking, microblogging, media sharing, messaging, business and consumer platforms, etc.

These services may further implement automated and intelligent decision-making operations and engines through AI systems, including rule-based engines and ecosystems. Rules may correspond to phrased conditions and corresponding actions that function as coded instructions implemented with a decision service or microservice that executes the coded instructions to perform an action, provide a service, or otherwise execute computing tasks. Rules may feature “if/then” logic and syntax designed to monitor and manage computing operations, such as risk associated with transactions or users who exhibit certain characteristics (e.g., malicious, suspicious, etc.). Rules may act on incoming data, scores and outputs from other AI systems including ML models and NNs, and the like. The decision services may determine if, when, and how a particular service may be provided to users. For example, risk rule engines may be utilized to determine whether electronic transaction processing of a requested digital transaction may proceed or be approved, whether an account should be flagged or restricted, whether a notification for an activity may issue, and the like. The risk engine may determine whether to proceed with processing the transaction or decline the transaction, as well as additional operations, such as request further authentication and/or information for better risk analysis, based on coded rule statements and/or instructions that may include natural language, code, and variables with corresponding syntax for rule execution of a computing task.

However, different data scientists and other users or engineers may generate different rules for different computing tasks, AI and rules-based engines, and the like, which may overlap in function and definition. This causes duplicated or similar rules that unnecessarily consume time and resources to create and waste storage and data processing resources while causing rule creation, testing, and deployment operations to have unnecessary and difficult to navigate features and operations. To address this problem of rule generation that may overlap or be duplicative, the service provider may implement a rule similarity detection and merging system using rule cluster and ML operations and models with a corresponding user interface (UI) to efficiently detect similar existing rules that may be deleted, merged, and/or reused for rule engineering and rule-based system deployment. This may significantly reduce rule testing and deployment, as well as rule system size and bloat, which may improve and make more efficient the underlying costs of developing, productizing, maintaining, and executing rule-based systems.

Different rules may utilize different syntax with statements, arguments, conditions, and/or variables. Variables may correspond to an individual measurable datum or pieces of data corresponding to a data record, such as a specific column or other recorded data for a property, characteristic, parameter, or the like for the data record (e.g., a transaction amount, date, payer and payee, etc., for a transaction). Variables may also correspond to outputs of other engines and/or models, such as ML model risk scores, and therefore may include different subjects or other language syntax objects or pieces. A UI system may allow data scientists and other users to write rules having syntax based on the code and corresponding statements, arguments, conditions, and/or variables. Using the UI system for rule similarity detection, the system may also detect similar rules that may exist and/or during rule construction, which may be detected from rule similarity pairs and clusters with a detailed summary of which parts of the rule syntax are identical, similar, and/or different. In this regard, syntax of rules may have language and/or code that may be used to generate vectors, which may correspond to mathematical representatives of the corresponding syntax of the rule based on natural language processing (NLP) or other syntax, word, and/or language analysis. For example, NLP and/or embedding operations may generate representative vectors of input data for syntax of rules.

The service provider's system may include and/or utilize components for creating and utilizing the tool with a generative AI, which may include a rule coding system's rule contents for different existing rules and rule creation objects (e.g., the structure or rule components of available rules). Different SQL and other files containing dynamic domains used in the rules and mappings between variable names in rule syntax and fields in the coded rules may be used to translate between rule syntax and offline SQL or other language or reverse. These files may include variable names and their corresponding fields, as well as a translation dataset having records that contain the translated rule/syntax and source. The records in the translation database may be used to fine-tune the model to support translating rules on-demand.

Upon receiving a request for rule translation and rule similarity detection, the system and tool may identify the rule type and preprocess the rule before sending it to a rule similarity detection engine (e.g., including an ML model or NN, such as a GPT-based LLM) along with the corresponding prompt for rule similarity detection. To facilitate this process, the system includes a data and model management component and a rule and rule code validation component, which may be linked with a gateway to various service provider interfaces, databases, and computing applications/services to handle incoming user requests and request orchestration. The engine may utilize these components to receive the request and generate a response, which is then post-processed by the system to ensure syntactic validity before sending back to the user. When providing the response, rule syntax may be used that is translated from an offline SQL logic or other computing code and logic, which may allow and assist users with quickly converting complex SQL statements into readable and manageable rule syntax in a corresponding language structure or pseudo-code. Additionally, the system may record user feedback, which serves as labeled training data for model adjustment and retraining in the future. Translation may utilize generative AI to generate and determine rule syntax from initial input rule logic, as well as compare such rule logic through similar syntax.

When generating the response, the rule syntax may be used, which may be processed based on pair-wise similarity to cluster same or similar rule pairs and perform rule similarity detection, merging, and/or deletion. This may be done using an ML system with a NLP that operates on the rule syntax to take input words, phrases, and language of rules and compare for the same or similar syntax, such as by using vectors generated from rule syntax. Vectors may be generated using a vectorization process for language and the rule syntax, such as a word2vec process or the like, and rules may be paired in a system so that similarity scores may be calculated between rules in the pair (e.g., a cosine similarity or Euclidean distance between two vectors for the rules in the pair). Clustering may then be performed based on rule similarity comparisons. A deep learning model or NN may be trained and used, which may include use of a Bidirectional Encoder Representations from Transformers (BERT) for NLP for rule syntax vectorization. The deep learning model for the NN may be trained using existing rules, rule syntax, and identification of overlapping rule syntax (e.g., training data labels) in order to determine if clustered rules have enough similarity to identify for overlap and therefore merging or deletion.

The deep learning model may provide a pipeline to check for rule similarity during clustering by training different layers that may perform rule similarity checks for rule pairs. After preprocessing and formatting of the rule logic to syntax of the rules in each pair, for each pair, the NN may check if the pair of rules conditions' logic is the same, inclusive, or opposite. The NN may then check if the pair of rules have their conditions' logic overlapping (e.g., a portion that is the same or similar in syntax). Finally, a fuzzy check may be performed of the rule syntax for overlapping syntax and the corresponding rule logic that is overlapping based on the syntax. An output of whether the rules overlap with a reason (e.g., identification of the overlapping syntax) and the rule similarity score may then be output by the NN. In some embodiments, generative AI may also be used when a query is received for comparisons between rules and rule syntax, which may be translated from rule logic and therefore allow a comparison of rules through an AI system.

Mergeable rule pairs may then be clustered so that each group of rules may have the potential to be merged (or have rules deleted) to result in a single or less rules. The ML clustering engine may access and/or receive the set of previously generated rule pairs and compute rule pair similarity clusters according to the similarity scores between rules and rule syntax. For clustering, one or more ML clustering algorithms may be utilized, such as a K-nearest neighbors (K-NN) classification algorithm (or other density, distribution, centroid, or hierarchical-based clustering that may be optimized for clustering using ML feature declarations and parameters). Rules may then be compared based on their corresponding parameters. Rule pairs may be identified that are similar within a threshold score or distance based on the vector from the rules' syntax, and an output may be provided to the user that shows the same or similar pairs of rules.

For example, with two or more rules that perform the same or similar function, an existing rule may be suggested (e.g., most similar, which may also include multiple rules similar within a similarity threshold score or distance). This may be output via the UI of the system, such as in one or more fields and may present the similarity score, clusters and/or cluster members of rules that are similar, and/or overlapping rule syntax (or rule logic after further translation back from the syntax). This allows the UI to show a most optimized rule or set of rules that exists in the rule modeling and processing system for selection in rule-based engines. Thus, the rule writers, data scientists, and/or other users may make optimized selections during rule modeling and construction based on existing rules instead of spending additional time during rule creation. Further, with simplified rules from rule comparisons, users may input a rule logic and have redundant logic with other rules removed from within the rule, returning a simplified rule. Results of rule analysis may therefore include providing rule logic or rule identifications to combine rules, identify overlap populations between rules, replace specific variables in the rule, and/or request rule-related information including rule performance, metadata, etc.

Using the merged and/or streamlined rules with decision services and other rule-based engines that deploy the rules for decision-making, a service provider, such as an online transaction processor (e.g., PAYPAL®), may more efficiently provide computing services to users, including electronic transaction processing that allows merchants, users, and other entities to process transactions, provide payments, and/or transfer funds between these users. When interacting with the service provider, the user may process a particular transaction and transactional data to provide a payment to another user or a third-party for items or services. Moreover, the user may view other digital accounts and/or digital wallet information, including a transaction history and other payment information associated with the user's payment instruments and/or digital wallet. The user may also interact with the service provider to establish an account and other information for the user. In further embodiments, other service providers may also provide computing services, including social networking, microblogging, media sharing, messaging, business and consumer platforms, etc. These computing services may be deployed across multiple different applications including different applications for different operating systems and/or device types. Furthermore, these services may utilize the aforementioned AI, ML, and/or NN models and systems for intelligent decision-making, classification, predictions, and other outputs, where rules for such systems may be streamlined, combined for efficiency, and condensed to converse system resources using the tool and UI for rule similarity detection.

In various embodiments and to utilize computing services, an account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation, as well as purchase or subscribe to services of the service provider. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. Access and use of these accounts may be performed in conjunction with uses of the aforementioned rules and rule-based engines. In this regard, rule may impact a user experience when utilizing the aforementioned account, payment, and other services of the service provider, such as when a payment is declined, a user is required to provide additional information, and/or an account is limited. However, this unnecessary friction may be reduced where, for example, if two or more rules are similar but have different restrictions, such rules may be identified and merged to reduce separate flows, appeal steps, and the like for resolution.

Thus, by using the tool and system to detect rule similarity and to manage a rule ecosystem, rule writers may more efficiently handle tedious and repetitive rule-related tasks, thereby automating rule similarity detection and rule logic to syntax translation, which eliminates or reduces the time the rule writers spend on redundant or unnecessary work. This may lead to increased efficiency and productivity of rule-based systems and engines, as well as improved decision-making capabilities. Additionally, by leveraging the power of generative AI, service providers may more efficiently and effectively automate management of rule writing and coding ecosystems, as well as rule execution processors and engines, ensuring that those computing systems and architectures are clean, efficient, and optimized.

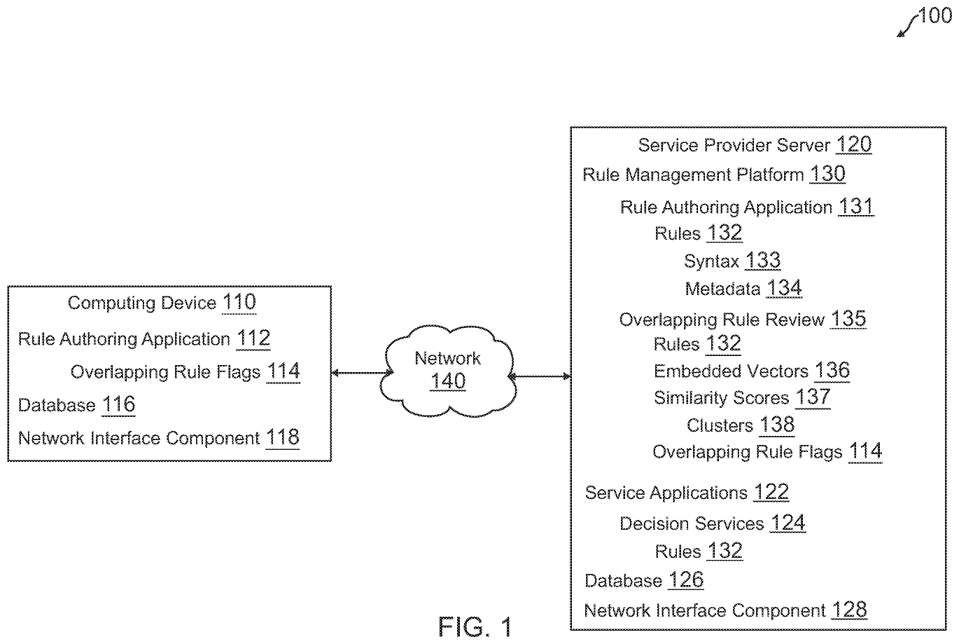

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT®OS, a UNIX®OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a computing device 110 and a service provider server 120 in communication over a network 140. Computing device 110 may be utilized by a user, such as a rule writer, to access a computing service or resource provided by service provider server 120, where service provider server 120 may provide various data, operations, and other functions to computing device 110 via network 140 including those associated with rule authoring and comparison for similarity detection, which may be used to deduplicate, merge, combine, and/or reduce rules in a system for improved system efficiency and resource usage. In this regard, computing device 110 may be used to perform rule authoring and/or review similarity comparisons of rules. Service provider server 120 may provide rule similarity detection using a NN, ML model, or other AI engine that compares rules using rule syntax translated from rule code and/or logic.

Computing device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Computing device 110 may be implemented as a communication device that may utilize appropriate hardware and software configured for wired and/or wireless communication with service provider server 120. For example, in one embodiment, computing device 110 may be implemented as a personal computer (PC), a smart phone, laptop/tablet computer, wristwatch with appropriate computer hardware resources, eyeglasses with appropriate computer hardware (e.g., GOOGLE GLASS @), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Computing device 110 of FIG. 1 contains a rule authoring application 112, a database 116, and a network interface component 118. Rule authoring application 112 may correspond to executable processes, procedures, and/or applications with associated hardware. In other embodiments, computing device 110 may include additional or different modules having specialized hardware and/or software as required.

Rule authoring application 112 may correspond to one or more processes to execute software modules and associated components of computing device 110 to provide features, services, and other operations for writing, constructing, and/or creating rules, as well as reviewing existing rules and rule comparisons from rule similarity detection. In this regard, rule authoring application 112 may correspond to specialized hardware and/or software utilized by a user of computing device 110 that may be used to access a website or UI provided by service provider server 120 for rule authoring and/or comparing operations. Rule authoring application 112 may utilize one or more UIs, such as graphical user interfaces presented using an output display device of computing device 110, to enable the user associated with computing device 110 to enter and/or view data, navigate between different data, UIs, and executable processes, and request processing operations based on services for rule authoring and comparing provided by service provider server 120, including those used to merge, delete, deduplicate, or otherwise streamline rules that are the same or similar in rule-based systems. In some embodiments, the UIs may display rules, variables, conditions, statements, arguments, and other rule parameters that may be used for rule creation and used with one or more rule-based systems including those with decision services, ML models and engines, and the like. In order to do this, rule authoring application 112 may render a UI during application execution, which may correspond to a webpage, domain, service, and/or platform provided by service provider server 120.

In some embodiments, rule and rule parameters considered for construction and/or generation using rule authoring application 112, such as based on selected rules parameters, may be compared to existing rules with one or more rule-based engines or rule construction systems for service provider server 120. For example, service provider server 120 may implement and utilize rules, such as fraud detection and/or other decision rules, with one or more processing engines, decision services, applications, and the like. Such computing services may be used with electronic transaction processing services and other intelligent decision-making, such as those associated with transaction processing, digital accounts and account services, user authentication and verification, digital payments, risk analysis and compliance, and the like. In further embodiments, different services may be provided that utilize ML models, including messaging, social networking, media posting or sharing, microblogging, data browsing and searching, online shopping, and other services available through online service providers.

During operation, such as when performing rule creation and/or rule comparison for merging or deleting the same or similar rules, rule authoring application 112 may display one or more operations, menus, fields, or the like for rule selection and/or input for rule logic, which may provide different rule parameters available to rule authoring application 112 (e.g., rule logic, such as SQL logic or other computing code and instructions) from input or loaded rule logic. Service provider server 120 may provide logic translation to syntax operations, where a deep learning model, such as a NN or other ML model and framework, may provide rule syntax comparisons and identification of the same, similar, or overlapping rules for rule similarity detection and reduction in rule duplication or overlap. Rule authoring application 112 may receive and display other similar rules that currently exist, were previously created, and/or are or were used by rule engines and/or rule authoring systems, such as overlapping rule flags 114 from service provider server 120 that were detected from existing rules and rule syntax comparisons. To do this, rule authoring application 112 may receive, access, and/or load overlapping rule flags 114 from overlapping rules detected by service provider server 120, where rule pair similarity scores, reasons for similarity or overlap, clusters over rule pairs, and the like may allow for rule merging or deleting. The input rule and rule logic therefore may be compared, such as through similarity and/or distance scores from rule syntax comparison, and an output of similar rules, rule syntax, clusters, members in similar clusters, and the like may be provided via overlapping rule flags 114.

Computing device 110 may further include database 116 stored on a transitory and/or non-transitory memory of computing device 110, which may store various applications and data and be utilized during execution of various modules of computing device 110. Database 116 may include, for example, identifiers such as operating system registry entries, cookies associated with rule authoring application 112 and/or other applications on computing device 110, identifiers associated with hardware of computing device 110, or other appropriate identifiers, such as identifiers used for payment/user/device authentication or identification, which may be communicated as identifying the user/computing device 110 to service provider server 120. Moreover, database 116 may include data and information used for similarity detection of rules, including rule logic for rules that are uploaded or designated for comparison, as well as overlapping rule flags 114 that may be stored for rule comparison and merging or deleting.

Computing device 110 includes at least one network interface component 118 adapted to communicate with service provider server 120 and/or other devices, servers, and components on network 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide services that use coded computing rules to process data, make decisions, perform detections, and the like during computing service provision. Such rules may be implemented with applications, platforms, decision services, and the like to perform automated decision-making in an intelligent system using rule-based engines, such as decision services and the like. In this regard, service provider server 120 includes one or more processing applications which may be configured to interact with computing device 110 to generate and deploy rules, which may include rule similarity detection to prevent unnecessary rule creation and provide preexisting rule consolidation through merging and deleting similar or overlapping rules. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a rule management platform 130, service applications 122, a database 126, and a network interface component 128. Rule management platform 130 and service applications 122 may correspond to executable processes, procedures, and/or applications with associated hardware. In other embodiments, service provider server 120 may include additional or different modules having specialized hardware and/or software as required.

Rule management platform 130 may correspond to one or more processes to execute modules and associated specialized hardware of service provider server 120 to provide a platform, application, and framework to generate, author, test and/or compare rules for decisions, data detection, and the like, which may correspond to logic for computing code that executes operations to make decisions, perform actions, and provide outputs based on input data. As such, rules may be used in decision services, rule-based engines, and the like for intelligent decision-making. In this regard, rule management platform 130 may correspond to specialized hardware and/or software used by service provider server 120 to provide rule authoring application 131, which may be used wiuth rules 132. In this regard, rules 132 may be written in corresponding rule logic having computing code executed to perform the rule function or computing task, which each have a syntax 133.

The coded logic may correspond to offline SQL logic or the like for rules, which may be loaded and processed to translate into syntax 133 that may be processed for similarity comparison and detection. The coded logic may correspond to computing code and coded instructions that is/are utilized to execute expressions for rules, such as statements, arguments, conditions, and/or variables for rule execution and performance of a computing task by a decision service. The logic translated to syntax 133 may therefore include corresponding coded instructions in a programming language or the like. Metadata 134 may also be associated with rules 132, which may be used during rule comparison and/or determination of syntax 133. For example, metadata 134 may include creation time, author, systems and engines utilizing the rule, linked data sources and/or rule processing information, descriptions, variable information, and the like, which may further provide information about the corresponding rule and/or intent of the rule (e.g., for determination of syntax 133 by providing context to corresponding logic).

When comparing rules 132 for deduplicating, merging, deleting, or the like, overlapping rule review 135 may include information for similarities between rules 132 from syntax 133, metadata 134, and the like. Similarity detection performed for overlapping rule review 135 may utilize a generative AI, NN, and/or ML model to compare and process input language from syntax 133 with metadata 134 for rule comparison. When processing rule comparisons for overlapping rule review 135, embedded vectors 136 may be generated by converting syntax 133 to vectors through a vector encoding process including word2vec, a BERT for NLP process, and/or a deep neural network (DNN or other NNs) having an encoding operation for vector encoding for DNN features. Similarity scores 137 may then be computed using pairwise similarity and clustering between different pairs of rules and their corresponding vectors from embedded vectors 136. The DNN may be trained using existing rules, rule syntax, and identification of overlapping rule syntax (e.g., training data labels) in order to determine similarity scores 137. Further, ML clustering models and ML generated clusters may be used to generate clusters 138, which may then be used for rule similarity comparison and output of overlapping rule flags 114 to computing device 110, which may flag rules based on similarity scores and reason for overlap or similarity (e.g., syntax that overlaps). Cluster-based models used to generate clusters 138 may include clustering using a clustering algorithm (e.g., density, distribution, centroid, or hierarchical-based clustering).

When determining overlapping rule flags 114, first a deep learning model, such as a DNN, or other ML model may be used for similarity detection and similarity score calculation or computation based on pairwise similarity between pairs of vectors (and therefore their corresponding rules having syntax 133). Such DNN may utilize a pipeline of comparisons and processing of the syntax and vectors from the corresponding syntax of the rules, which may include comparing rules conditions' logic, determining whether rules have their conditions' logic overlapping, and performing a fuzzy check of the rule syntax for overlapping syntax. For the DNN pipeline, decision tree ML models and/or NNs may be used. Decision trees may include one or more input nodes or other mathematical computations associated with features, additional or hidden processing nodes, and output nodes that form branches where different computations at each node, activation functions, thresholds or value computations and comparisons, and the like may be used to proceed down different branches to a particular output. Similarly, NNs may use nodes linked in different layers to form neurons that may include input, hidden, and output layers. ML models with multiple layers, including an input layer, one or more hidden layers, and an output layer having one or more nodes, may be used. Each node within a layer is connected to a node within an adjacent layer, where a set of input values may be used to generate one or more output values or classifications. Within the input layer, each node may correspond to a distinct attribute or input data type that is used for the ML model algorithms using feature or attribute extraction for input data.

Thereafter, the internal, interceding, or hidden layers and/or nodes may be generated with these attributes and corresponding weights using an ML or deep learning algorithm, computation, and/or technique. For example, each of the nodes in the hidden or internal layers generates a representation, which may include a mathematical ML or NN computation (or algorithm) that produces a value based on the input values of the input nodes. The algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values that provide an output, classification, prediction, or the like. Thus, when the ML or NN model is used to perform a predictive analysis and output, the input may provide a corresponding output based on the trained classifications.

With a NN, by providing input data when training the DNN, the nodes in the layers may be adjusted such that an optimal output (e.g., a classification) is produced in the output layer. By continuously providing different sets of data and penalizing the NN when the output of the NN is incorrect (e.g., rules are not determined to be similar), the NN (and specifically, the representations of the nodes in the layers, branches, neurons, or the like) may be adjusted to improve its performance in data classification, such as whether rules are similar when performing pairwise similarity comparison. Thereafter, based on pairwise similarity scores and other outputs, clustering may be performed to look for and identify opportunities for rule reduction through merging, deleting, or otherwise consolidating rules for rule system efficiency. The ML clustering may result in cluster data that may be used for similarity detection of similar, matching, or corresponding rules having similarity scores indicating a high enough degree of overlap for rule simplification by deleting, merging, or otherwise reducing the overlapping rules. The clustering may therefore be used to generate clusters of similar rules that are output as overlapping rule flags 114. Overlapping rule review 135 may include cluster data for cluster 138 to perform rule similarity detection in order to reduce duplicated rules and/or overlapping rules that accomplish the same or similar effects in order to reduce system load, stress, excess data and rule processing operations, and unnecessary or confusing rule availability and use. This also reduces the time and processing costs of designing and generating new rules when new rule engines are configured and/or existing rule-based engines and systems are updated, reconfigured, or retrained.

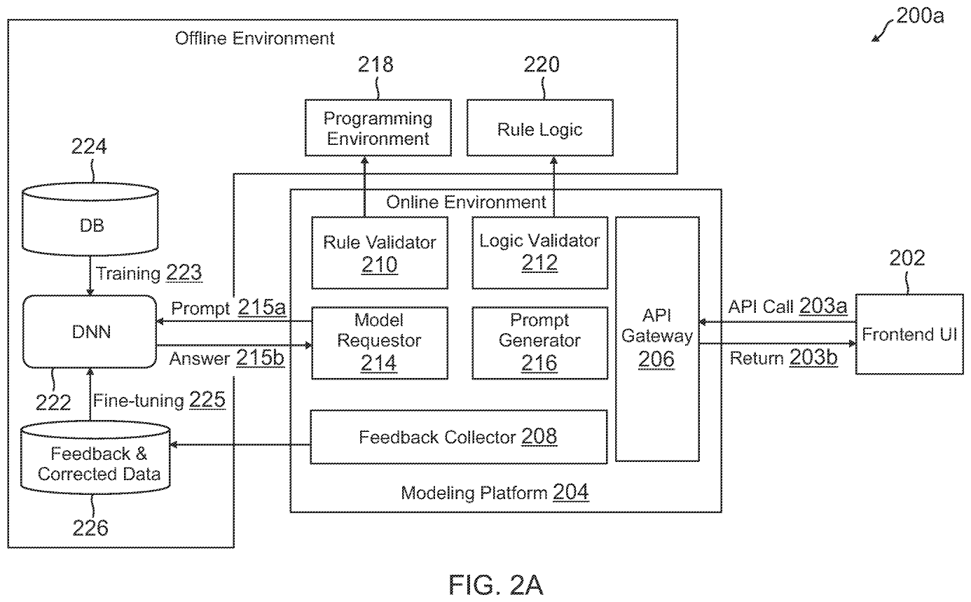

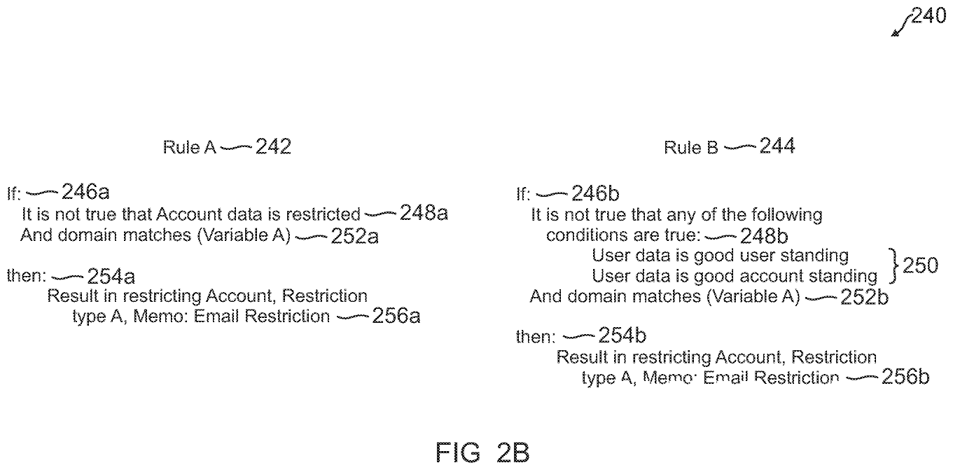

Overlapping rule review 135 includes a feature clustering process that may correspond to one or more of density, distribution, centroid, or hierarchical-based clustering for different data points, such as similarity scores and vector representations of pairwise vector similarities. Overlapping rule review 135 may, to generate clusters 138, execute operations that implement or use a clustering algorithm, such as a K-NN classification algorithm or other supervised or unsupervised learning classifier that may perform classifications and/or predictions by grouping data points based on similarity scores, distance scores or functions, and the like. In some embodiments, similarity scores may correspond to measurements between vectors, such as cosine similarity or Euclidean distance. The clustering algorithm may be used to generate clusters 138. Overlapping rule flags 114 may then be generated and output. Processes to compare rules through rule syntax with DNNs and clustering models is described in further detail with regard to FIGS. 2A-4 below. Overlapping rule flags 114 may then be output, which may include similarity scores for pairwise similarities between overlapping rules, reason for overlap (e.g., based on syntax), and/or portions of overlapping syntax, which may be output to one or more users via a UI system and/or UI of an application.

In some embodiments, to provide such output explanations, a generative AI may be used to explain rule similarities and/or syntax overlap between rules. With the explanation from the generative AI, overlapping rule flags may include recommendations to combine, retire, modify, or otherwise change existing rules after identification of potentially overlapping rules. For example, where two or more rules may have overlapping syntax that may cause the rules to function in the same or similar manner, one or more of those rules may be combined, retired, or deleted to reduce the number of existing rules and utilize a more universal rule for rule-based engines. The generative AI may provide a chat-based feature where a user may ask for comparisons of rules and the explanation may be provided to the user with identification of the overlapping syntax and other information for overlapping rule flags 114. As such, overlapping rule flags 114 with explanations and information from a generative AI may assist in reducing overlapping and/or unnecessary rules that may adversely affect rule-based systems.

Service applications 122 may correspond to one or more processes to execute modules and associated specialized hardware of service provider server 120 to process a transaction or provide another computing service, which may be assisted by deployment of rules 132 in decision services 124 from rule management platform 130. In this regard, service applications 122 may correspond to specialized hardware and/or software used by a user associated with computing device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 120. In some embodiments, the financial information may also be used to establish a payment account. Accounts may be accessed and/or used through one or more instances of a web browser application and/or dedicated software application executed by computing device 110 and engage in computing services provided by service applications 122.

The account may be accessed and/or used through a browser application and/or dedicated payment application executed by computing device 110 and engage in transaction processing through service applications 122. Service applications 122 may process the payment and may provide a transaction history to computing device 110 for transaction authorization, approval, or denial. Such account services, account setup, authentication, electronic transaction processing, and other services of service applications 122 may utilize decision services 124 using rules 132, such as for risk analysis, fraud detection, and the like. In other embodiments, service applications 122 may instead provide different computing services, including social networking, microblogging, media sharing, messaging, business and consumer platforms, etc. Such services may similarly utilize deployed ML models for intelligent outputs.

Service applications 122 may also provide additional features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider server 120, where the user or other users may interact with the GUI to more easily view and communicate information. In various embodiments, service applications 122 may include additional connection and/or communication applications, which may be utilized to communicate information to over network 140.

Additionally, service provider server 120 includes database 126. Database 126 may store various identifiers associated with computing device 110. Database 126 may also store account data, including payment instruments and authentication credentials, as well as transaction processing histories and data for processed transactions. Database 126 may store financial information and tokenization data. Data for rules 132 may be stored by database 126, which may include data used for rule comparison such as syntax 133, metadata 134, and/or similarity scores 137 with clusters 138.

In various embodiments, service provider server 120 includes at least one network interface component 128 adapted to communicate computing device 110 and/or other devices or servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2A is an exemplary system environment 200 where rules may be implemented and evaluated to control overlapping rule code, according to an embodiment. System environment 200 of FIG. 2 includes an online or real-time processing environment that may implement rules in decision services and rule-based engines and an offline or asynchronous (e.g., not in real-time) processing environment that may provide rules and rule logic for processing. In this regard, the online processing environment may be used by rule authoring application 112 through a frontend UI 202 to interact with a modeling platform 204 of rule management platform 130 discussed in reference to system 100 of FIG. 1. In this regard, frontend UI 202 may be provided to rule authors and the like on a computing device, such as computing device 110 of FIG. 1, to request operations, navigate between UIs and data, and otherwise interact with service provider server 120 for rule similarity detection and merging or deleting rules for rule system efficiency and optimization.

System environment 200 shows how rule management platform 130 may interact with different components to process rules based on translated rule syntax in order to compute rule pairwise similarities and cluster pairwise rules from rule merging and reduction. In this regard, modeling platform 204 may include operations to train and utilize a DNN 222 for rule comparison, which may include a generative pre-training transformer (GPT)-based large language model (LLM). Modeling platform 204 may correspond generally to a web service, application, or other online platform where a data scientist, modeler, or other user may model and train one or more NNs, ML models, and the like for rule similarity detection. To do so, modeling platform 204 may receive requests and interact with frontend UI 202 through an API gateway 206 to receive an API call 203a and return a response 203b, such as those calls and responses used for model training of DNN 222. As such, modeling platform 204 may correspond to and/or include functionalities described in reference to rule management platform 130 in system 100 of FIG. 1. Modeling platform 204 further includes a feedback collector 208 to further interact with frontend UI 202 based on feedback from users via frontend UI 202 and the like. Feedback may correspond to identification of whether rule similarity detections were correct or incorrect, as well as overlapping portions of rule syntaxes that cause positive or negative similarities. For example, based on an output during testing of a model, a data scientist may provide feedback that identifies whether the similarity detection and/or identification of overlapping rule syntax was correct or incorrect, which may be used to adjust and fine-tune a model, NN, or the like.

After receiving a request for model training via API call 203a from frontend UI 202, a rule validator 210 may interact with a programming environment 218 to validate rules that have been deployed and determine rule code and logic. A logic validator 212 may also interact with rule logic 220 to obtain and validate logic of rules that are processed by DNN 222. In this regard, rule validator 210 and logic validator 212 may provide rule logic, which may then be processed by DNN. A model requestor 214 may interact with DNN in conjunction with prompt generator 216 to generate prompts for rule similarity detection of rule. In this regard, prompt generator 216 may generate a prompt 215a to train and/or compare rules based on pairwise linking of rules and their similarity. An answer 215b may be returned from prompt 215a during training, which may include an identification of overlapping syntax between rules and/or an explanation of the rule and syntax overlap (e.g., which portion of the rule syntaxes overlap or cause the rules to function the same or similarly).

Prompts generated by prompt generator 216 may include translated logic for the rules from rule validator 210 and logic validator 212 into syntax, which may be provided to DNN using model requestor 214. DNN 222 may include operations to receive the prompt during a training 223 and utilize a database 224 to train on rules and rule labels for model similarity. During training 223, feedback and corrected data 226 may also be used perform a fine-tuning 225 of the model, which may include applying feedback and corrected data 226 to adjust weights, activation functions, and the like of the model during training 223. Later during deployment, DNN 222 may further receive queries and generative AI prompts (e.g., requests to compare 2 or more rules based on rule syntaxes), which may use DNN 222, such as the GPT-based LLM, to provide an answer on rule similarity. Such responses may then be provided via modeling platform 204 back to frontend UI 202.

FIG. 2B is an exemplary diagram 240 of two rules having overlapping rule code that may be implemented as shown in FIG. 2A, according to an embodiment. Diagram 240 includes a rule A 242 that may be compared to a rule B 244 based on rule syntaxes. In this regard, similarities in the syntaxes may be determined by service provider server 120, discussed in reference to system 100 of FIG. 1, for use in rule similarity detection. For example, in diagram 240, rule A 242 and rule B 244 may correspond to two rules provided by model requestor 214 during prompt 215a to perform training 223 of DNN 222.

Different rule syntaxes are shown in diagram 240, where rule A 242 includes an if condition 246a having if condition syntax 248a that states “If it is not true that Account data is restricted, And domain matches” with a variable 252a of “Variable A”. With rule B 244, an if condition 246b includes if condition syntax 248b that states “It is not true that any of the following conditions are true:” with conditions 250 of “User data is good user standing” and “User data is good account standing.” If condition 246b continues with “and domain matches” with a variable 252b also of “Variable A.”

Further for rule comparison and overlap detection in rule similarity, then statement syntaxes 254a and 254b are also compared. Then statement syntax 254a states “Result in restricting Account, Restriction type A, Memo: Email Restriction.” Then statement syntax 254b states the same of “Result in restricting Account, Restriction type A, Memo: Email Restriction.” As such, there may be a significant amount of overlap between rule A 242 and rule B 244, which may indicate a possibility for merging or otherwise changing, deleting, or revising one or more of rule A 242 and/or rule B 244. For example, an exemplary generative AI response, such as a GPT-based LLM response, may be: “Yes, the two rule logics have overlapped conditions in their syntaxes and can be merged into one. The overlap occurs with the condition where the domain matches case-insensitively. To merge the rules, we can combine the conditions for each rule to simplify the logic.”

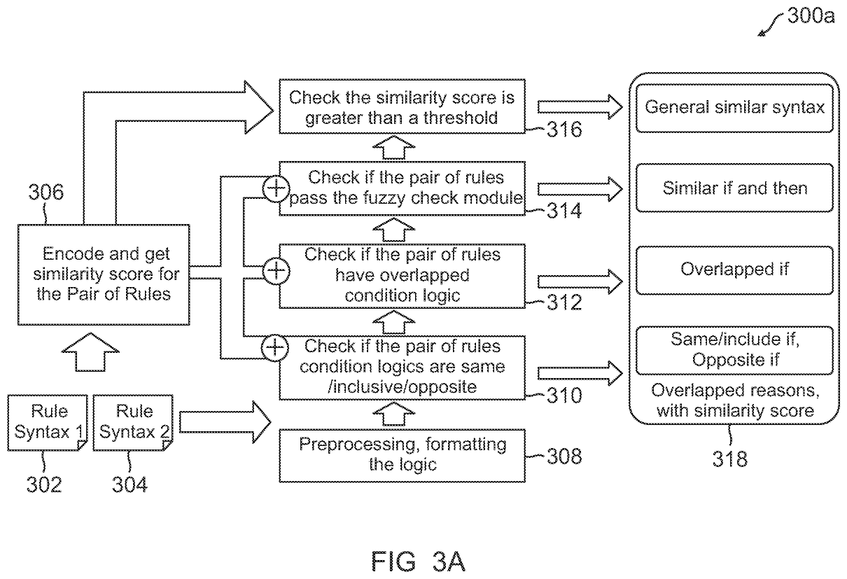

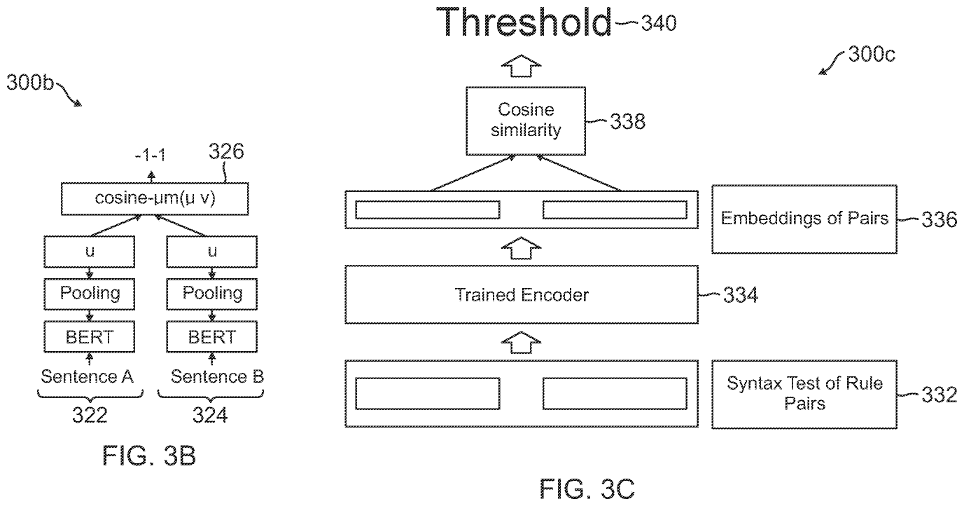

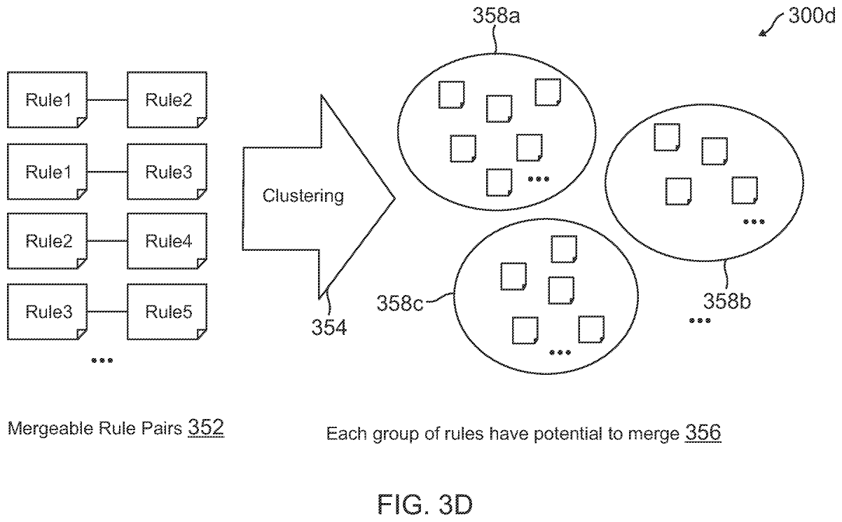

FIGS. 3A-3D are exemplary diagrams 300a-300d of operations to analyze rule syntax to identify, evaluate, and control overlapping rule code, according to an embodiment. Diagrams 300a-300d correspond to exemplary flows of a DNN or other ML model and system that performs rule similarity detection, such as rule management platform 130 of service provider server 120 in system 100 of FIG. 1. As such, diagrams 300a-300d may process rules, including those similar to rule A 242 and/or rule B 244 in diagram 240 of FIG. 2B, to determine similar rules for rule merging or deletion in rule-based systems.

In diagram 300a of FIG. 3A, a rule syntax 1 302 and a rule syntax 2 304 are compared using a DNN. For example, a Rule 1 for rule syntax 302 may correspond to: if VAR value of variable (“v1”)>“100” and VAR value of variable (“v2”)=“2” and VAR value of variable (“v3”)>“4”; then VAR define “v99” of value (“1”). A rule 2 for rule syntax 2 304 may correspond to: if VAR value of variable (“v1”)>“1000” and VAR value of variable (“v2”)=“2”; then VAR define “v99” of value (“1”). Another example of a first rule may be: if VAR value of variable (“v1”) does not equals “1”; then VAR define “v4” of value (“1”). That first rule may be compared to another rule based on syntax, where the second rule may be: if VAR value of variable (“v1”) equals “2”; then VAR define “v4” of value (“3”).

Initially, the syntax of each rule is inputted into an encoder, which converts it into a vector representation. Then conduct a score calculation 306 for the pair of rule syntax 1 302 and rule syntax 2 304. This may be done by encoding a vector representation of rule syntax 1 302 and rule syntax 2 304, which may then be compared in a vector space, such as through cosine similarity, Euclidean distance, or the like. The output of similarity score calculation 306 may then be stored for use by the DNN. In a parallel processing pathway, rule syntax 1 302 and rule syntax 2 304 may go through preprocessing and formatting 308 in order to provide as input to the steps (e.g., DNN rule check steps 310-316) of the DNN for processing in a pipeline to determine pairwise similarity and rule syntax overlap. Preprocessing and formatting 308 may include preparing the data into a format that may be processed by the DNN, such as by converting data to numerical or mathematical representations (e.g., from categorical data), cleaning data columns, providing null values or the like for missing data, and otherwise providing an output data format for the DNN.

During a first step and check of the DNN, a DNN rule check step 310 may check if the pair of rule syntax 1 302 and rule syntax 2 304 have condition logics that are the same, inclusive, or opposite. For example, with regard to rule A 242 and rule B 244, condition logic that has been translated to syntax (e.g., if conditions 246a and 246b) may be compared and used to determine if such rule logic is the same, inclusive, or opposite. If so, overlapped reason 318 may be output that indicates this similarity, inclusivity, or opposite. A DNN rule check step 312 may then determine if the pair of rules have overlapped condition logic, such as if all or a portion of the syntax overlaps in the conditions. For example, with regard to conditions 246a and 246b in diagram 240, if all or a portion of condition syntaxes 248a and 248b overlap or are similar, DNN rule check step 312 may result in a positive identification of overlap. Thus, a positive identification of overlap may be provided in overlapped reason 318 if so.

Finally, a DNN rule check step 314 may then perform a fuzzy check using a fuzzy check module. A fuzzy check may perform a fuzzy search or fuzzy comparison using a fuzzy search algorithm to perform matching based on approximate patterns in the syntax. The primary step in fuzzy matching may involve normalizing the syntax of the rule while disregarding details such as variables' values. The fuzzy matching may then verify if the majority of the logic matches. For example, with the above Rule 1 and Rule 2 discussed with regard to rule syntax 1 302 and rule syntax 2 304, a fuzzy match may be based on 1. Both rules sharing the condition “VAR value of variable (“v2”)=“2””, 2. Both rules use the variable v1, but with different values, and 3. The majority of variables are common between the two rules. A positive fuzzy check may have a corresponding reason provided in overlapped reasons 318. During a final DNN rule check step 316 of the DNN, the similarity score is again invoked and, from similarity score calculation 306, the similarity score is checked whether it meets or exceeds a threshold, such as a range of scores (e.g., 0.7-0.9) or a specific threshold score (e.g., a 0.9 similarity score). 0.9 may be selected as the threshold to focus on high confidence outputs generated by the models, but alternative values may be utilized as well. If so, the rules may be identified as similar and flagged with the similarity score and reason(s) from overlapped reason 318.

Diagrams 300b and 300c in FIGS. 3B and 3C show simplified computations of cosine similarity or other vector similarity comparison that may be performed when determining rule similarity. For example, in diagram 300b, a sentence A 322 is compared with a sentence B 324 by using a BERT encoder with a pooling layer to generate a vector u and a vector v that are compared as the cosine similarity 326, such as a measure of the angle between vectors, from −1 to 1. With regard to rules that have a syntax, in diagram 300c, syntax text of the rule pairs 332 is provided as input to a trained encoder 334. The trained encoder may be used to encode vectors as mathematical representations of syntax text from rule pairs 332. Embeddings of rule pairs 336, such as the embedded vectors, may be output, which, in a similar manner to diagram 300b, may be used to compute a cosine similarity 338. Cosine similarity 338 may then be compared to a threshold 340, such as a cosine similarity threshold score or value of 0.9 (on a scale of −1 to 1, where 1 is the same vector and −1 are opposite vectors), to determine whether the pair of rules are sufficiently similar for review and clustering to merge, delete, or revise.

In diagram 300d of FIG. 3D, pairs of rules are clustered based on pairwise similarity and flagged for review or modification. Mergeable rule pairs 352 may be provided as input with their corresponding similarity scores to a clustering operation 354 for a potential rule merging 356 of clusters 358a-358c. When generating clusters 358a-358c, pairwise rule similarity from mergeable rule pairs 352 may be represented in a space and clustered according to their similarity scores or other representations and the clustering algorithm. This allows for identification of pairs of rules that may have similar logic and syntax. Clustering operation 354 of rules allows for identification of similar and/or overlapping rules so that comparisons of a new or existing rules may be performed and potential rule merging 356 provided. Clustering operation 354 may correspond to graph-based clustering, where a graph-based clustering method may represent data as a graph and nodes represent the individual elements. Edges between nodes may therefore represent relationships between such nodes. In this regard, the steps to perform such graph-based clustering may include convert the dataset into a graph, with each data point as a node and relationships between data points as edges, and thereafter identifying or detecting clusters or subgraphs within the graph where nodes are connected, either directly or indirectly. As such, each node may be a rule and the edges connecting may be whether the rules are “similar” (e.g., meeting or exceeding the threshold similarity score). Potential rule merging 356 may lighten the processing load for rule systems by reducing existing rules. As such, when outputting flags of clusters 358a358c, a rule author or other user may simplify and optimize the rule-based system.

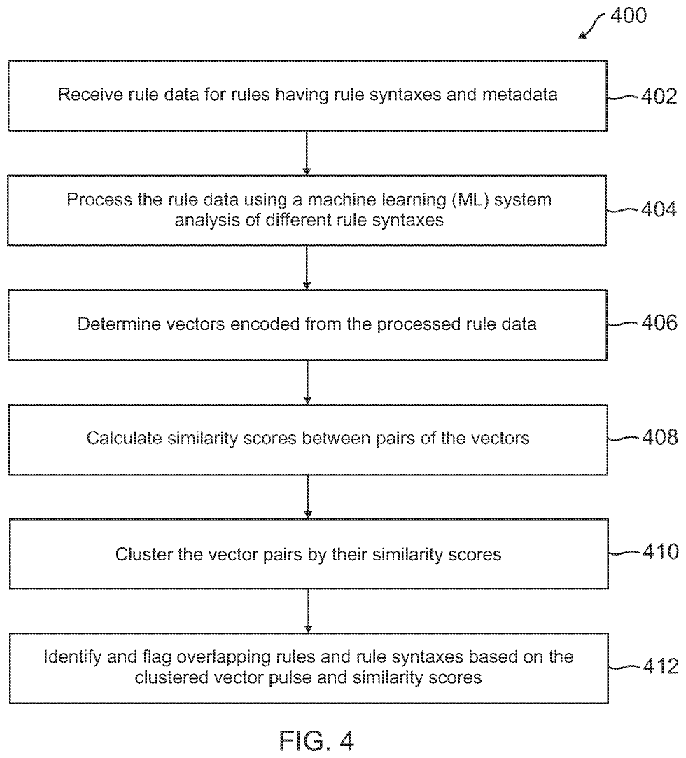

FIG. 4 is a flowchart 400 of an exemplary process performed by a system for identifying, evaluating, and controlling overlapping rule code, according to an embodiment. Note that one or more steps, processes, and methods described herein of flowchart 400 may be omitted, performed in a different sequence, or combined as desired or appropriate. Flowchart 400 of FIG. 4 includes operations the system performs for identifying, evaluating, and controlling overlapping rule code, as discussed in reference to FIGS. 1-3D above. One or more of steps 402-412 of flowchart 400 may be implemented, at least in part, in the form of executable code stored on non-transitory, tangible, machine-readable media that when run by one or more processors may cause the one or more processors to perform one or more of steps 402-412. In some embodiments, flowchart 400 may be performed by one or more computing devices, servers, and/or components discussed in system 100 of FIG. 1.

At step 402 of flowchart 400, rule data for rules having rule syntaxes and metadata is received. For example, in system 100, service provider server 120 may receive and/or access rule data for rules 132 that may include syntax 133 translated from coded rule logic and metadata 134 accompanying the rule logic and/or rule data (e.g., for files, containers, objects, etc., for the rules). Rule data may include at least rule logic and other code needed for execution of the rule and may further include translated syntax generated from the rule. The syntax may be translated using a generative AI, DNN or ML model, or other AI system that may take input logic, such as SQL logic for rule execution, and provide output syntax of the rule that may be processed using a NLP and/or generative AI during rule comparison (e.g., based on overlapping syntax and other language for the rules statements, arguments, conditions, and/or variables).

At step 404, the rule data is processed using an ML system analysis of different rule syntaxes. Service provider server 120 in system 100 may process syntax 133 and metadata 134 using overlapping rule review 135 that may implement an ML model, DNN, or the like for computing pairwise similarity of rules and clustering such rules. The analysis of the different rule syntaxes may be done using an NLP analysis, such as an analysis of the words and word construction/order in the syntaxes of the rules. Overlapping rule review 135 may include data preprocessing and formatting operations to convert or process data to prepare the data for ML model or DNN processing, which may include preparing data for generating embedded vector 136. An exemplary syntax of rules that may be compared is shown in diagram 200b of FIG. 2B with rule A 242 and rule B 244. At step 406, vectors encoded from the processed rule data is determined. In system 100, service provider server 120 may generate embedded vectors 136 using the ML model or DNN of overlapping rule review 135. Embedded vectors 136 may be generated by encoding data to numerical or mathematical representations of n-dimensions, where n may correspond to the input features, such as using word2vec, BERT for NLP embedding, or the like.

At step 408, the similarity scores between pairs of the vectors is calculated. Service provider server 120 in system 100 may use embedded vectors 136 to compute similarity scores 137 using an ML model or DNN, which may utilize a multi-phased or pipeline of intelligent comparison operations based on underlying portions of syntax 133 that overlaps between rules 132. For example, similarity scores may correspond to cosine similarities between vectors, as well as other similarity or vector distance calculations (e.g., Euclidean distance between vectors). The similarity scores may be computed by the DNN based on rule syntax for two rules in a pairwise rule similarity computation, such as rule syntax 1 302 and rule syntax 2 304 when processed in diagram 300a of FIG. 3A. In this regard, a plurality of phases for computation in a pipeline of decision-making by the DNN may be used, such as DNN rule check steps 310-316. This may include a check of whether condition logic are the same inclusive, or opposite, a condition logic check for overlap, a fuzzy check, and/or a similarity score check for the DNN, as discussed herein.

At step 410, the vector pairs are clustered by the similarity scores. Service provider server 120 in system 100 may execute overlapping rule review 135 to cluster, which then utilizes a ML clustering operation and/or technique to cluster similarity scores and/or pairwise rule computations to cluster such pairwise similarities for rule merging and the like. As such, overlapping rule review 135 may determine clusters 138 from similarity scores 137. After processing of the pairwise similarity between rule syntaxes of rules, clustering may be performed to generate clusters 358a-358c that may allow for groups of rules to merge into single groups, such as using an ML clustering algorithm.

At step 412, overlapping rules and rule syntaxes are identified and flagged based on the clustered vector pairs and similarity scores. Based on similarity scores 137 and clusters 138, service provider server 120 may generate overlapping rule flags 114 that may then be output to computing device 110 for viewing and interacting via rule authoring application 112. Overlapping rules may be flagged, and those flagged may be output within a UI and rule review system for deduplication, merging and the like. This may include output of clusters 358a-358c, as well as the pairwise similarities and similarity scores from those pairwise similarity checks. Further, explanations for the overlapping syntax and/or the overlapping portions of the syntax between rules may be output, such as using a generative AI, which may correspond to overlapped reasons 318 from diagram 300a of FIG. 3A.

As discussed above and further emphasized here, flowchart 400 of FIG. 4 may be executed by service provider server 120 when determining rule similarities, such as to provide an AI system for identifying, evaluating, and controlling overlapping rule code, which examples should not be used to unduly limit the scope of the claims. One of ordinary skill in the art would recognize many variations, alternatives, and modifications.

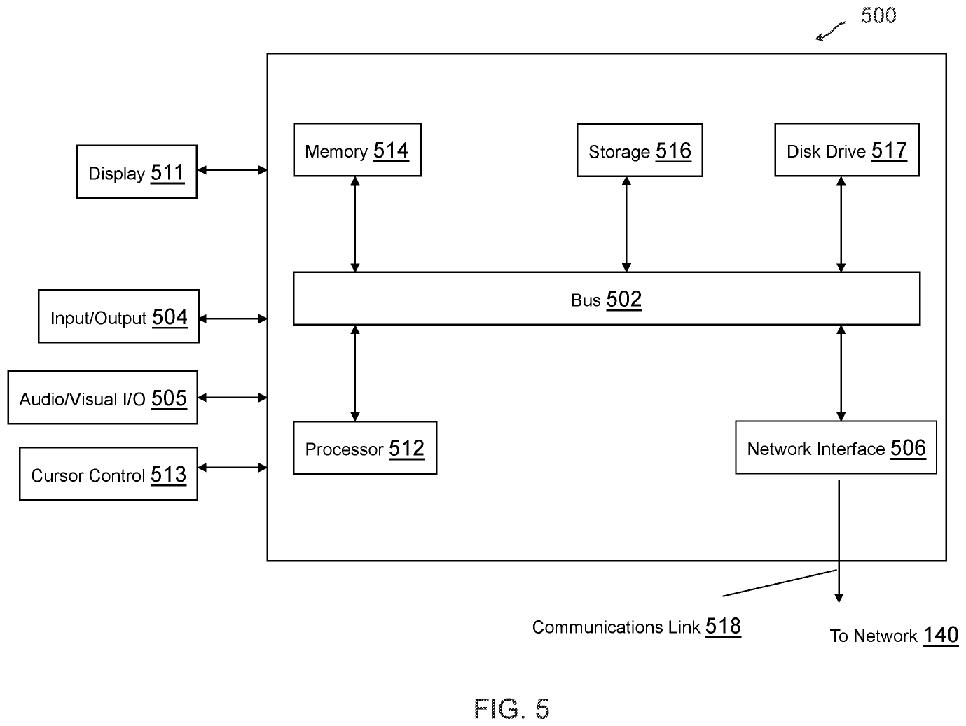

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing rule data for a plurality of rules using a machine learning (ML) system comprising a first ML model configured for natural language processing (NLP) analysis of rule syntaxes for the plurality of rules, wherein the plurality of rules are associated with coded instructions for computing tasks by decision services associated with the system, and wherein the rule data comprises the rule syntaxes for the plurality of rules;
determining a plurality of vectors for the plurality of rules from the rule syntaxes using the first ML model;
computing similarity scores of each of the plurality of vectors to other ones of the plurality of vectors;
comparing the plurality of vectors based on the similarity scores;
identifying a first rule that overlaps with a second rule within a similarity threshold based on the comparing; and
flagging the first rule and the second rule based on the identifying.

2. The system of claim 1, wherein the operations further comprise:
generating syntax similarity data for the first rule overlapping with the second rule, wherein the syntax similarity data comprises an identification of an overlap between the first rule and the second rule and one of the similarity scores computed for the first rule with the second rule; and
outputting the syntax similarity data.

3. The system of claim 2, wherein the syntax similarity data further comprises a reason for an overlap in the rule syntaxes of the first rule and the second rule based on at least one of rule conditions, rule variables, or rule metadata.

4. The system of claim 1, wherein the comparing comprises
clustering the similarity scores using a second ML model of the ML system, wherein the second ML model comprises an ML clustering technique associated with the similarity scores; and
performing a similarity analysis of the rule syntaxes for the plurality of rules based on the clustering and the similarity threshold.

5. The system of claim 4, wherein the operations further comprise:
outputting, via a user interface of the ML system, a plurality of clusters of the similarity scores based on the clustering, wherein the plurality of clusters identify pairs of the plurality of rules belonging to each of the plurality of clusters.

6. The system of claim 1, wherein the determining the plurality of vectors comprises encoding a plurality of embeddings from the rule syntaxes and metadata for the plurality of rules using the first ML model, and wherein the first ML model comprises a deep neural network (DNN).

7. The system of claim 6, wherein the DNN is trained on previous outputs for the NLP analysis of the plurality of rules and feedback to the NLP analysis using a supervised learning technique.

8. The system of claim 1, wherein the computing the similarity scores uses one of a cosine similarity technique or a Euclidean distance technique.

9. The system of claim 1, wherein the plurality of rules correspond to decision rules for the decision services utilized by one or more applications or computing components of the system, and wherein the decision rules have the rule syntaxes based on the coded instructions and metadata for the decision rules.

10. The system of claim 1, wherein the operations further comprise:
receiving a request to change one of the first rule or the second rule based on the identifying the first rule overlapping the second rule within the similarity threshold; and
adjusting at least one rule engine utilizing the one of the first rule or the second rule, wherein the adjusting performs at least one of a combining, a retiring, or a modifying of the one of the first rule or the second rule.

11. A method comprising:
receiving a first rule syntax for a first rule and a second rule syntax for a second rule, wherein the first rule and the second rule comprise coded instructions for computing tasks by decision services of a service provider;
executing a first machine learning (ML) model configured for analysis of the first rule syntax and the second rule syntax;
generating, using the executed first ML model, a first vector for the first rule syntax and a second vector for the second rule syntax;
computing a similarity score of the first rule syntax to the second rule syntax;
determining whether the first rule and the second rule have overlapping rule syntaxes based on the similarity score and a syntax similarity threshold; and
providing rule overlap information for at least the first rule and the second rule via a rule authoring application of the service provider.

12. The method of claim 11, wherein, based on the first rule and the second rule being determined to have the overlapping rule syntaxes, the method further comprises:
flagging the first rule and the second rule for overlapping rule review in the rule authoring application for the decision services of the service provider.

13. The method of claim 12, further comprising:
providing a reason for the flagging with the overlapping rule review, wherein the reason comprises at least one or more rule syntax portions causing the overlapping rule syntaxes between the first rule syntax and the second rule syntax and the similarity score.

14. The method of claim 11, wherein, prior to the generating, the method further comprises:
preprocessing and formatting the first rule syntax and the second rule syntax for an embedding operation of the executed first ML model.

15. The method of claim 11, wherein the generating the first vector and the second vector comprises:
determining data for a plurality of model features from the first rule syntax and the second rule syntax and metadata for the first rule and the second rule; and
encoding embeddings for the first vector and the second vector from the data.

16. The method of claim 15, wherein the embeddings are associated with rule conditions, rule variables, and rule logic from the first rule syntax, the second rule syntax, and the metadata.

17. The method of claim 11, wherein, prior to the determining whether the first rule and the second rule have the overlapping rule syntaxes, the method further comprises:
clustering the similarity score with a plurality of other similarity scores using a second ML model comprising an ML clustering technique.

18. The method of claim 17, further comprising:
providing a user interface including data associated with the similarity score and the overlapping rule syntaxes, wherein the user interface includes an option to replace or delete one or more of the first rule or the second rule.

19. A non-transitory machine-readable medium having stored thereon machine-readable instructions executable to cause a machine to perform operations comprising:
generating a plurality of vectors for a plurality of rules based on a plurality of rule syntaxes for the plurality of rules using an ML engine configured for syntax analysis of the plurality of rule syntaxes for the plurality of rules, wherein the plurality of rules are associated with coded instructions for computing tasks by decision services of a service provider;
computing a plurality of similarity scores of each of the plurality of vectors to other ones of the plurality of vectors;
determining that a first rule of the plurality of rules has a first rule syntax of the plurality of rule syntaxes that overlaps with a second rule having a second rule syntax based on one of the plurality of similarity scores for a first vector of the plurality of vectors for the first rule to a second vector for the second rule meeting or exceeding a threshold similarity score; and
outputting, via a rule authoring application associated with the plurality of rule, at least the one of the plurality of similarity scores with an identification of the first rule syntax overlapping the second rule syntax.

20. The non-transitory machine-readable medium of claim 19, wherein the identification further comprises portions of the first rule syntax that overlap with the second rule syntax.
